(19) United States
(12) Patent Application Publication
(10) Pub. No.: US 2026/0138492 A1
(43) Pub. Date: May 21, 2026

(54) BATTERY REPLACEMENT DEVICE

(71) Applicant: ISUZU MOTORS LIMITED, Yokohama-shi (JP)

(72) Inventor: Muneyuki OSAWA, Fujisawa-shi (JP)

(21) Appl. No.: 19/350,403

(22) Filed: Oct. 6, 2025

(30) Foreign Application Priority Data
Nov. 19, 2024 (JP) 2024-201331

(51) Int. Cl. B60L 53/80; H01M 50/244; H01M 50/256; H01M 50/262

(52) U.S. Cl. CPC B60L 53/80; H01M 50/244; H01M 50/256; H01M 50/262

(57) ABSTRACT

A battery replacement device includes a first lifting frame that is capable of being raised and lowered, a second lifting frame that is capable of being raised and lowered in a direction opposite to that of the first lifting frame, a linear connecting member that has one end portion connected to the first lifting frame and the other end portion connected to the second lifting frame, a driving unit that moves the connecting member, and a pulley that supports the connecting member, wherein the driving unit moves the connecting member to cause the second lifting frame to be lowered as the first lifting frame is raised, and moves the connecting member to cause the second lifting frame to be raised as the first lifting frame is lowered.

### CROSS-REFERENCE TO RELATED APPLICATIONS

The present application claims priority to Japanese Patent Applications number 2024-201331, filed on November 19, 2024 contents of which are incorporated herein by reference in their entirety.

### BACKGROUND OF THE INVENTION

The present disclosure relates to a battery replacement device.

Japanese Unexamined Patent Application Publication No. 2014-935 discloses a replacement system in which a battery of a vehicle is automatically replaced. In this replacement system, a gripping means, which is movable along a rail, is raised and lowered while gripping the battery, thereby performing a replacement operation of the battery in an upper portion of the vehicle.

In a vehicle equipped with a plurality of replaceable batteries, it is necessary to replace the plurality of batteries. However, the gripping means of the above-described replacement system grips only a single battery, which results in a prolonged time required to replace the plurality of batteries.

A method of moving a plurality of batteries up and down with the single gripping means may be proposed, but in this case, it is necessary to increase a size of a driving unit for operating the gripping means.

### BRIEF SUMMARY OF THE INVENTION

The present disclosure focuses on this point, and an object thereof is to appropriately move a plurality of batteries up and down with a small-sized driving unit. An aspect of the present disclosure provides a battery replacement device that includes a first lifting frame that holds a first battery and is capable of being raised and lowered, a second lifting frame that holds a second battery and is capable of being raised and lowered in a direction opposite to that of the first lifting frame, a linear connecting member with a predetermined length that i) is provided above the first lifting frame and the second lifting frame and ii) has one end portion connected to the first lifting frame and the other end portion connected to the second lifting frame, a driving unit that moves the connecting member, and a pulley that supports the connecting member, wherein the driving unit moves the connecting member to cause the second lifting frame to be lowered as the first lifting frame is raised, and moves the connecting member to cause the second lifting frame to be raised as the first lifting frame is lowered.

### BRIEF DESCRIPTION OF THE DRAWINGS

FIG. 1 schematically shows a battery replacement system 1 according to an embodiment.

FIG. 2 shows a configuration of a battery replacement device 20.

FIG. 3 schematically shows a state in which a first lifting frame 30A is located at a replacement position.

FIG. 4 schematically shows a state in which the first lifting frame 30A is located at a second accommodation position.

FIG. 5 schematically shows a state in which the first lifting frame 30A is located at a first accommodation position.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of battery replacement system

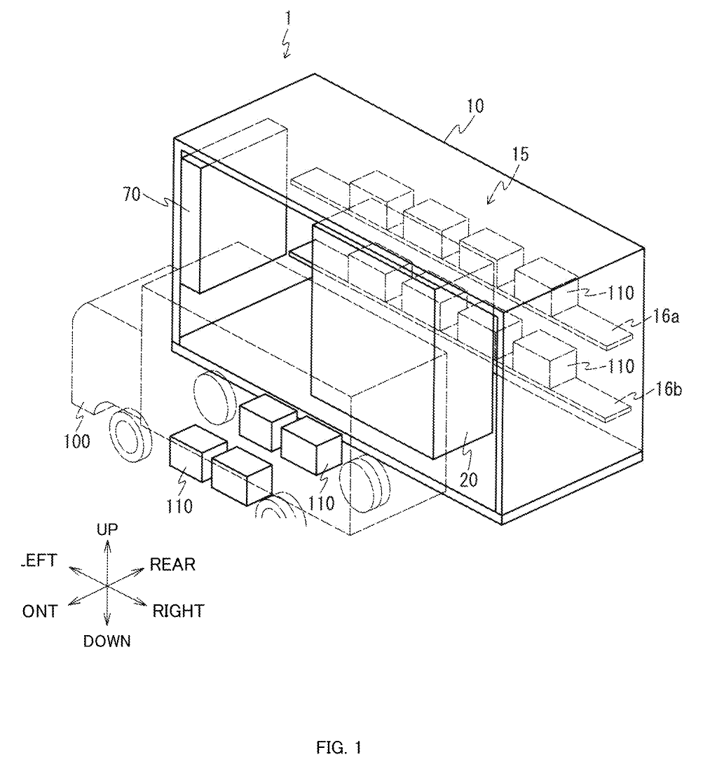

FIG. 1 schematically shows a battery replacement system 1 according to an embodiment. It should be noted that, in FIG. 1, the battery replacement system 1 is provided only on a right side of the vehicle 100 (rear in a front-rear direction shown in FIG. 1), but is not limited thereto. For example, the battery replacement system 1 may be located on both sides of the vehicle 100.

The battery replacement system 1 is a system that replaces a battery 110 of the vehicle 100. The vehicle 100 is a large-sized vehicle such as a truck or a bus, for example. When the vehicle 100 stops at a predetermined position (in FIG. 1, in front of the battery replacement system 1), the battery replacement system 1 automatically replaces the battery 110.

The battery replacement system 1 includes a container 10, an accommodation portion 15, a battery replacement device 20, and a control unit 70.

The container 10 is formed in a large box shape and has a space therein. The front-rear direction, a left-right direction, and an up-down direction shown in FIG. 1 and the like are directions when the battery replacement system 1 is viewed from the front.

The accommodation portion 15 is provided inside the container 10, and is a shelf that accommodates the battery 110. The accommodation portion 15 has an upper stage 16a and a lower stage 16b that are separated from each other in the vertical direction. A battery 110 that has been charged by a charging facility is placed on the upper stage 16a and the lower stage 16b. The accommodation portion 15 is provided in the rear in the front-rear direction shown in FIG. 1, inside the container 10.

The battery replacement device 20 removes the battery 110 mounted on the vehicle 100 from the vehicle 100 and accommodates the battery in the accommodation portion 15. Further, the battery replacement device 20 takes out the charged battery 110 accommodated in the accommodation portion 15 from the accommodation portion 15 and mounts the battery to the vehicle 100. The battery replacement device 20 is provided in the front in the front-rear direction in FIG. 1, inside the container 10.

The control unit 70 controls the operation of the battery replacement device 20 to automatically replace the battery 110 on the vehicle 100. Further, the control unit 70 performs control to charge the battery 110 accommodated in the accommodation portion 15 with the charging facility.

### Detailed configuration of battery replacement device

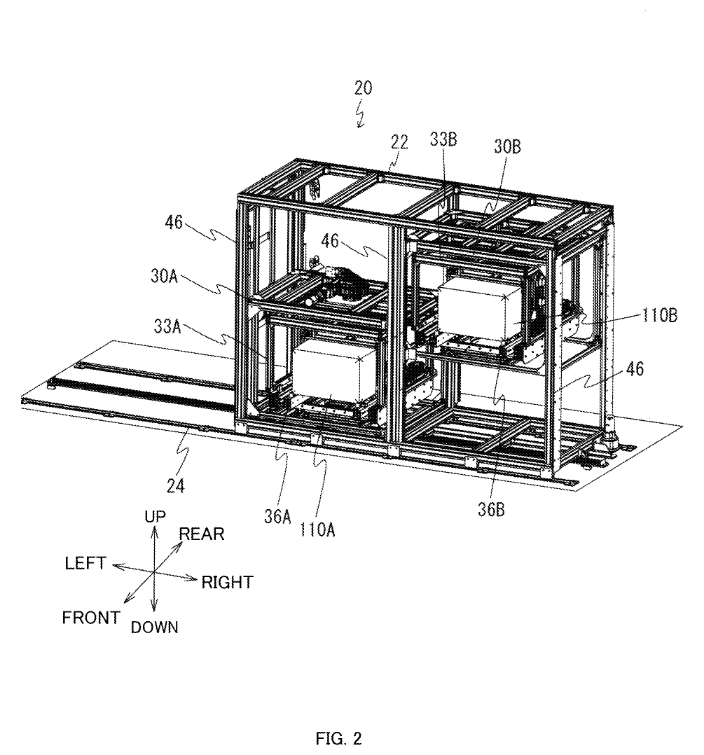

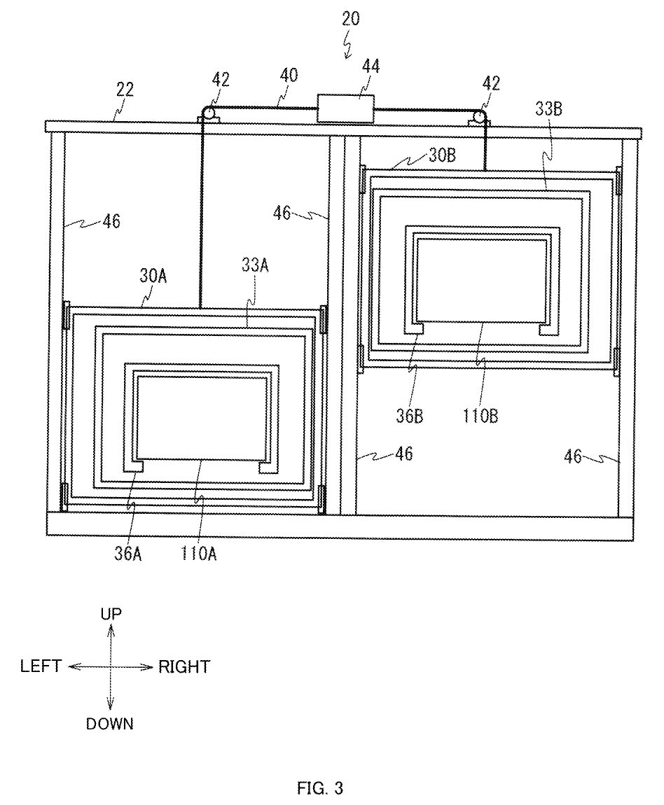

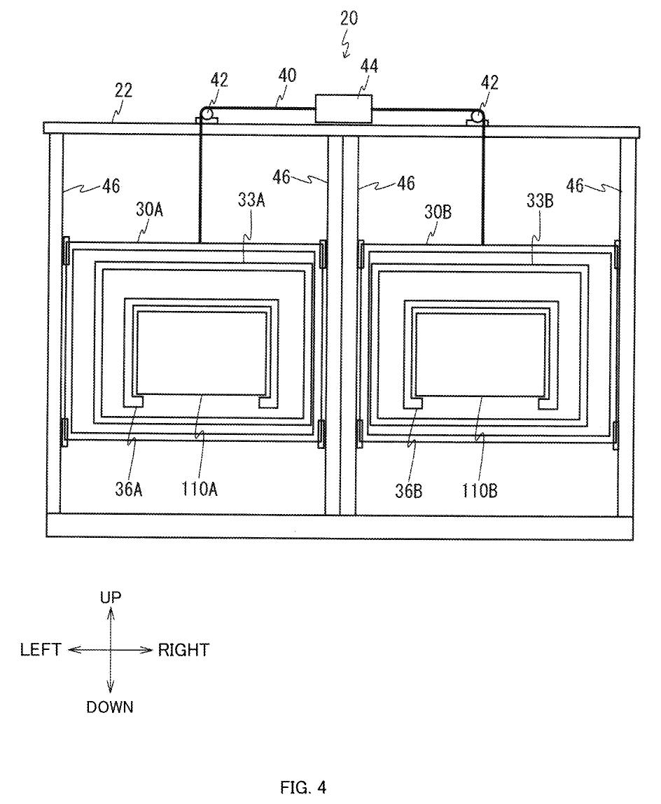

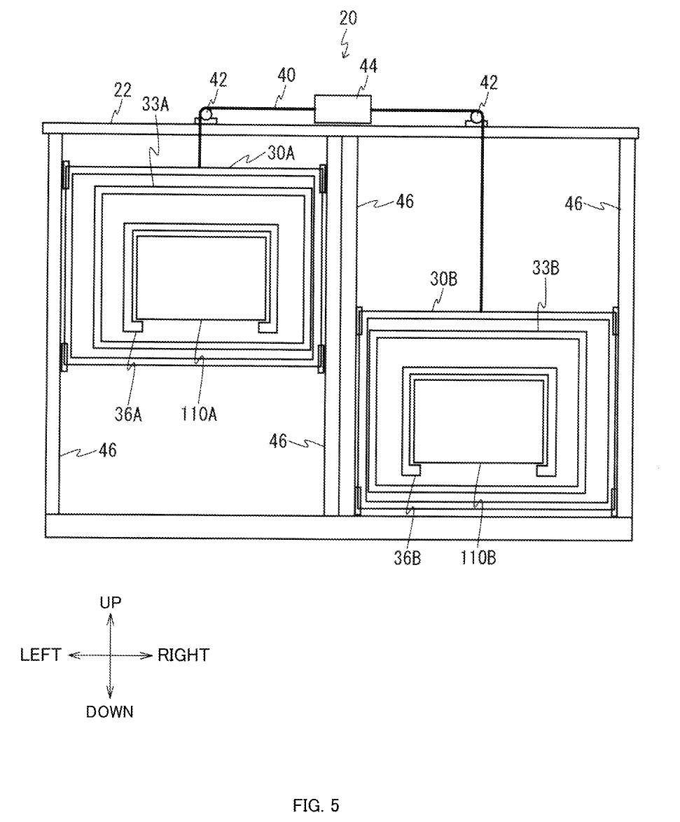

FIG. 2 shows a configuration of the battery replacement device 20. FIG. 3 schematically shows a state in which a first lifting frame 30A is located at a replacement position. FIG. 4 schematically shows a state in which the first lifting frame 30A is located at a second accommodation position. FIG. 5 schematically shows a state in which the first lifting frame 30A is located at a first accommodation position. It should be noted that, in FIG. 2, a connecting member 40, a pulley 42, and a driving unit 44 are omitted for convenience of description. In FIG. 3 to FIG. 5, configurations of the first lifting frame 30A and a second lifting frame 30B are simplified, and travel rails 24 are omitted.

As shown in FIG. 3, the battery replacement device 20 includes a housing 22, the first lifting frame 30A, the second lifting frame 30B, the connecting member 40, the pulley 42, the driving unit 44, and a guide portion 46.

The housing 22 is formed in a box shape and constitutes a framework of the battery replacement device 20. The housing 22 is movable on the travel rails 24 shown in FIG. 2. The travel rails 24 are provided along the left-right direction (direction perpendicular to the front-rear direction), and the housing 22 moves in the left-right direction due to the driving force from an actuator such as a motor.

The first lifting frame 30A is provided in the housing 22, and is a frame located on the left in the left-right direction. As shown in FIG. 3 to FIG. 5, the first lifting frame 30A can be raised and lowered in a vertical direction orthogonal to the front-rear direction and the left-right direction. Specifically, the first lifting frame 30A is raised and lowered, along the guide portion 46 provided in the housing 22, by the driving force from the driving unit 44. The first lifting frame 30A holds a first battery 110A. The first lifting frame 30A is raised and lowered while holding the first battery 110A.

The first lifting frame 30A can be located at a plurality of positions in the vertical direction (lifting direction). Specifically, the first lifting frame 30A is raised and lowered between the replacement position (a position shown in FIG. 3), the first accommodation position (a position shown in FIG. 5), and the second accommodation position (a position shown in FIG. 4). The replacement position is a lowermost end position in the vertical direction, the first accommodation position is an uppermost end position in the vertical direction, and the second accommodation position is a position between the replacement position and the first accommodation position in the vertical direction. The first lifting frame 30A can stop at the replacement position, the first accommodation position, and the second accommodation position.

When the first lifting frame 30A is positioned at the replacement position, the first battery 110A is mounted on the vehicle 100 or removed from the vehicle 100. When the first lifting frame 30A is positioned at the first accommodation position, the first battery 110A held by the first lifting frame 30A can be accommodated in the upper stage 16a (FIG. 1) of the accommodation portion 15, and when the first lifting frame 30A is positioned at the second accommodation position, the first battery 110A held by the first lifting frame 30A can be accommodated in the lower stage 16b (FIG. 1) of the accommodation portion 15.

The first lifting frame 30A includes a first turning frame 33A and a first arm 36A.

The first turning frame 33A turns the held first battery 110A. The first turning frame 33A is rotatably supported with respect to the first lifting frame 30A. Specifically, the first turning frame 33A is provided in the first lifting frame 30A and rotates in the first lifting frame 30A. The first turning frame 33A rotates so as to turn the first battery 110A.

The first turning frame 33A turns the first battery 110A by 180 degrees between a first position where the held first battery 110A faces forward in the front-rear direction and a second position where it faces rearward in the front-rear direction. The first position is a position where the first battery 110A faces the vehicle 100, and the second position is a position where the first battery 110A faces the accommodation portion 15.

The first turning frame 33A turns the first battery 110A while the first lifting frame 30A is being raised and lowered. For example, the first turning frame 33A starts to turn the first battery 110A when the first lifting frame 30A to be raised and begins to be lowered.

The first arm 36A holds the first battery 110A that can be mounted on and removed from the vehicle 100. The first arm 36A is slidably supported with respect to the first turning frame 33A. The first arm 36A slides in the up-down direction and the front-rear direction while holding the first battery 110A. The first turning frame 33A is provided with rails so that the first arm 36A can slide. This enables the first arm 36A to easily accommodate the first battery 110A in the accommodation portion 15. Further, the first arm 36A is slidable so that, even if the vehicle 100 stops at a position deviating from a stop position relative to the battery replacement device 20, the first battery 110A can be easily mounted on a predetermined position of the vehicle 100 and easily removed from the vehicle 100.

The second lifting frame 30B is provided in the housing 22, and is a frame located on the right in the left-right direction. As shown in FIG. 3 to FIG. 5, the second lifting frame 30B is vertically movable. Specifically, the second lifting frame 30B is raised and lowered along the guide portion 46 provided in the housing 22 by the driving force from the driving unit 44. In the embodiment, the second lifting frame 30B is not raised and lowered in the same direction as the first lifting frame 30A, but is raised and lowered in a direction opposite to that of the first lifting frame 30A. That is, the second lifting frame 30B is lowered when the first lifting frame 30A is raised, and is raised when the first lifting frame 30A is lowered.

The second lifting frame 30B can be positioned at a plurality of positions in the vertical direction (lifting direction). Specifically, similarly to the first lifting frame 30A, the second lifting frame 30B is raised and lowered between a replacement position (a position shown in FIG. 5) in which the second battery 110B is mounted on the vehicle 100, a first accommodation position (a position shown in FIG. 3) in which the second battery 110B is accommodated in the upper stage 16a of the accommodation portion 15, and a second accommodation position (a position shown in FIG. 4) in which the second battery 110B is accommodated in the lower stage 16b of the accommodation portion 15. The second lifting frame 30B can be stopped at the replacement position, the first accommodation position, and the second accommodation position.

The second lifting frame 30B includes a second turning frame 33B and a second arm 36B.

The second turning frame 33B turns the held second battery 110B. The second turning frame 33B is rotatably supported with respect to the second lifting frame 30B, and rotates so as to turn the second battery 110B.

The second turning frame 33B turns the second battery 110B while the second lifting frame 30B is being raised and lowered. For example, the second turning frame 33B starts to turn the second battery 110B when the second lifting frame 30B begins to be raised and begins to be lowered. In this case, a timing at which the second turning frame 33B turns the second battery 110B is the same as a timing at which the first turning frame 33A turns the first battery 110A.

However, the present disclosure is not limited thereto, and the timing at which the second turning frame 33B turns the second battery 110B may be different from the timing at which the first turning frame 33A turns the first battery 110A. For example, the second turning frame 33B may turn the second battery 110B when the turning of the first battery 110A by the first turning frame 33A is ended. Accordingly, for example, it is possible to prevent the first turning frame 33A and the second turning frame 33B from interfering with each other during turning.

The second arm 36B holds the second battery 110B that can be mounted on and removed from the vehicle 100. The second arm 36B is slidably supported with respect to the second turning frame 33B. The second arm 36B slides in the up-down direction and the front-rear direction while holding the second battery 110B. This enables the second arm 36B to easily accommodate the second battery 110B in the accommodation portion 15. Further, the second arm 36B is slidable so that, even if the vehicle 100 stops at a position deviating from a stop position relative to the battery replacement device 20, the second battery 110b can be easily mounted on a predetermined position of the vehicle 100 and easily removed from the vehicle 100.

The connecting member 40 is a member that connects the first lifting frame 30A and the second lifting frame 30B. Specifically, one end portion of the connecting member 40 is connected to the first lifting frame 30A, and the other end portion of the connecting member 40 is connected to the second lifting frame 30B. The connecting member 40 is provided above the first lifting frame 30A and the second lifting frame 30B. Specifically, the connecting member 40 is provided so as to be supported at the center of an upper portion of the housing 22.

The connecting member 40 is a linear member having a predetermined length, and is a chain, for example. However, it is not limited thereto, and the connecting member 40 may be a wire or a belt. By using such a connecting member 40, the first lifting frame 30A and the second lifting frame 30B can be raised and lowered simultaneously in opposite directions in the vertical direction.

The pulley 42 movably supports the connecting member 40. Here, the pulley 42 is a fixed pulley that is fixed to the upper portion of the housing 22. Two pulleys 42 are provided here, wherein one pulley 42 is located on the left side of the driving unit 44 and the other pulley 42 is located on the right side of the driving unit 44. Specifically, the one pulley 42 is a first pulley located above the first lifting frame 30A, and the other pulley 42 is a second pulley located above the second lifting frame 30B. The connecting member 40 is movably in contact with the outer circumferential surfaces of the two pulleys 42. Since the two pulleys 42 are provided above the first lifting frame 30A and the second lifting frame 30B as described above, the first lifting frame 30A and the second lifting frame 30B can be smoothly raised and lowered.

Here, the driving unit 44 is a motor and moves the connecting member 40. Here, the driving unit 44 moves the connecting member 40 in the left-right direction to raise and lower the first lifting frame 30A and the second lifting frame 30B. For example, the driving unit 44 moves the connecting member 40 to the right to raise the first lifting frame 30A and lower the second lifting frame 30B. In this case, the first lifting frame 30A functions as a counterweight, and the second lifting frame 30B can be smoothly lowered even though a dedicated counterweight is not provided.

On the other hand, the driving unit 44 moves the connecting member 40 to the left to raise the second lifting frame 30B and lower the first lifting frame 30A. In this case, the second lifting frame 30B functions as a counterweight, and the first lifting frame 30A can be smoothly lowered even though a dedicated counterweight is not provided.

The driving unit 44 moves the connecting member 40 so that the first lifting frame 30A and the second lifting frame 30B are positioned at predetermined positions. For example, the driving unit 44 moves the connecting member 40 so as to position the first lifting frame 30A at the first accommodation position and position the second lifting frame 30B at the replacement position in the lifting direction, as shown in FIG. 5. In this case, the first battery 110A can be accommodated in the accommodation portion 15 while the second battery 110B is mounted on the vehicle 100. Similarly, as shown in FIG. 4, the driving unit 44 positions the first lifting frame 30A at the second accommodation position and positions the second lifting frame 30B at the second accommodation position. Further, as shown in FIG. 3, the driving unit 44 positions the first lifting frame 30A at the replacement position and positions the second lifting frame 30B at the first accommodation position.

A method in which the first turning frame 33A and the second turning frame 33B are supported by a single lifting frame and the single lifting frame is raised and lowered may be considered. In this method, since the single lifting frame is raised and lowered, the first turning frame 33A and the second turning frame 33B are raised or lowered simultaneously. In this case, since the weight of the frame raised and lowered by the driving unit increases, a driving unit capable of generating a large driving force is required. In addition, in the above-described method, it is necessary to provide a dedicated counterweight in the housing 22 in order to smoothly raise and lower the lifting frame.

In contrast, in the present embodiment, when one of the first lifting frame 30A and the second lifting frame 30B is raised, the other is lowered, so that the driving force of the driving unit 44 can be reduced. Further, since one of the first lifting frame 30A and the second lifting frame 30B functions as a counterweight, it is not necessary to provide a dedicated counterweight, thereby downsizing the battery replacement device 20.

Description of the configuration of the present embodiment will be continued.

The guide portion 46 guides the vertical movement of the first lifting frame 30A and the second lifting frame 30B. The guide portion 46 is a guide member provided on the frame of the housing 22 along the vertical direction. By providing the guide portion 46, it is possible to stabilize the postures of the first lifting frame 30A and the second lifting frame 30B when the first lifting frame 30A and the second lifting frame 30B connected to the connecting member 40 are raised and lowered.

### Effects of Embodiment

The battery replacement device 20 of the above-described embodiment includes a linear connecting member 40 that connects the first lifting frame 30A and the second lifting frame 30B capable of being raised and lowered in opposite directions to each other, a pulley 42 that movably supports the connecting member 40, and a driving unit 44 that rotates the pulley 42. The pulley 42 causes the second lifting frame 30B to be lowered as the first lifting frame 30A is raised when rotating in the forward direction, and causes the second lifting frame 30B to be raised as the first lifting frame 30A is lowered when rotating in the reverse direction.

Accordingly, when the first lifting frame 30A and the second lifting frame 30B are raised and lowered, one of them functions as a counterweight, and it is not necessary to provide a dedicated counterweight. In addition, since one of the first lifting frame 30A and the second lifting frame 30B is pulled, the driving force of the driving unit 44 can be reduced as compared with the case where both the first lifting frame 30A and the second lifting frame 30B are pulled, and thus the driving unit 44 can be downsized.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A battery replacement device comprising:
a first lifting frame that holds a first battery and is capable of being raised and lowered;
a second lifting frame that holds a second battery and is capable of being raised and lowered in a direction opposite to that of the first lifting frame;
a linear connecting member with a predetermined length that i) is provided above the first lifting frame and the second lifting frame and ii) has one end portion connected to the first lifting frame and the other end portion connected to the second lifting frame;
a driving unit that moves the connecting member; and
a pulley that supports the connecting member, wherein
the driving unit moves the connecting member to cause the second lifting frame to be lowered as the first lifting frame is raised, and moves the connecting member to cause the second lifting frame to be raised as the first lifting frame is lowered.

2. The battery replacement device according to claim 1, wherein
the first lifting frame and the second lifting frame are capable of being positioned at a plurality of positions in a lifting direction, and
the driving unit moves the connecting member so that the first lifting frame is positioned at an uppermost end position in the lifting direction and the second lifting frame is positioned at a lowermost end position in the lifting direction.

3. The battery replacement device according to claim 1, wherein
the first lifting frame includes a first arm configured to hold the first battery that can be mounted on and removed from the vehicle, and
the second lifting frame includes a second arm configured to hold the second battery that can be mounted on and removed from the vehicle.

4. The battery replacement device according to claim 3, wherein
the first arm i) mounts the first battery on the vehicle when the first lifting frame is positioned at a replacement position in the lifting direction, and ii) accommodates the first battery in an accommodation portion when positioned at an accommodation position where the first battery is accommodated in the accommodation portion for charging the first battery, and
the second arm i) mounts the second battery on the vehicle when the second lifting frame is positioned at a replacement position in the lifting direction, and ii) accommodates the second battery in an accommodation portion when positioned at the accommodation position where the second battery is accommodated in the accommodation portion for charging the second battery.

5. The battery replacement device according to claim 1, wherein
the first lifting frame includes a first turning frame that turns the held first battery, and
the second lifting frame includes a second turning frame that turns the held second battery.

6. The battery replacement device according to claim 5, wherein
the first turning frame turns the first battery while the first lifting frame is being raised and lowered, and
the second turning frame turns the second battery while the second lifting frame is being raised and lowered.

7. The battery replacement device according to claim 6, wherein
a timing at which the first turning frame turns the first battery is different from a timing at which the second turning frame turns the second battery.

8. The battery replacement device according to claim 1, further comprising:
a guide portion that guides the first lifting frame and the second lifting frame to be raised and lowered in opposite directions.

9. The battery replacement device according to claim 1, wherein
the pulley includes a first pulley located above the first lifting frame and a second pulley located above the second lifting frame.

10. The battery replacement device according to claim 1, wherein
the connecting member is a chain.
